(19) United States
(12) Patent Application Publication
(10) Pub. No.: US 2025/0245994 A1
(43) Pub. Date: Jul. 31, 2025

(54) WORKSTATION SYSTEM FOR AUTOMATED INSPECTION OF ROBOTICALLY OR MANUALLY PERFORMED DEXTEROUS TASKS

(71) Applicant: Rapta Inc., Lake Oswego, OR (US)

(72) Inventors: Matthias DAUE, Portland, OR (US); Aaron BROWN, Lake Oswego, OR (US); Matthew THORNTON, Lake Oswego, OR (US)

(21) Appl. No.: 19/037,185

(22) Filed: Jan. 25, 2025

Related U.S. Application Data
(60) Provisional application No. 63/626,672, filed on Jan. 30, 2024.
(60) Provisional application No. 63/689,570, filed on Aug. 30, 2024.

(51) Int. Cl. G06V 20/52; B25J 9/16; G06V 10/774; G06V 10/82; G06V 10/94; G06V 20/40; G06V 30/19; H04N 7/18; H04N 23/62; H04N 23/695

(52) U.S. Cl. CPC G06V 20/52; B25J 9/163; G06V 10/774; G06V 10/82; G06V 10/945; G06V 20/41; G06V 30/19147; H04N 7/183; H04N 23/62; H04N 23/695; G06V 2201/06

(57) ABSTRACT

A modular inspection assembly is designed for automated inspection of workpieces in various manufacturing environments. The system includes a camera mounted on a linear rail with a carriage, allowing movement along one or more axes to enable adjustable positioning of the camera relative to an inspection target. A gimbal system provides rotational movement of the camera around one or more degrees of freedom, facilitating the capture of various inspection angles. An integrated AI industrial computer and image processing unit manage the positioning, movement, and operation of the camera, linear rail, and gimbal system. This setup allows for both discrete, preconfigured inspection poses and continuous dynamic inspection through tracking shots. The modular design ensures flexible and real-time inspection capabilities, enhancing quality control and adaptability across different manufacturing processes. The system is particularly suited for environments requiring precise inspection of complex assemblies, where traditional fixed inspection setups may fall short.

### RELATED APPLICATIONS

This application claims priority benefit of U.S. Provisional Patent Application Nos. 63/689,570 filed Aug. 30, 2024, and 63/626,672 filed Jan. 30, 2024. Each application is hereby incorporated by reference in its entirety.

### TECHNICAL FIELD

This application relates generally to image or video recognition or understanding using machine learning and neural networks and, more particularly, to orchestration of AI models for inspection of work.

### BACKGROUND INFORMATION

Previous assembly process training and quality assurance were largely manual. For example, training new employees typically involved the use of photographs or written text documenting each step of the assembly process. These photographs would be compiled into binders or manuals, which served as the primary learning tools for new workers. This method was straightforward but lacked interactivity and real-time feedback, which are crucial for effective and rapid skill development and breaking learning curve, a known and proven challenge for humans.

Quality assurance inspections in these settings were often ad hoc. Inspectors would periodically review products or processes manually, but this approach was inconsistent and risked missing subtle defects or issues. The manual nature of these inspections meant that defects might not be identified until later stages, potentially leading to increased waste or product recalls. Further, inspections conducted after a complex assembly is completed risk missing internal problems (within the assembly) that are not visible during the final inspection stage.

For defect inspection, some specialized systems did exist, typically involving purpose-built machine vision systems such as those using Cognex or Keyence cameras. These systems utilized custom-built software to identify defects during the manufacturing process. However, these machine vision systems were generally designed for specific tasks and were not easily adaptable to new or rapidly changing production requirements. This lack of flexibility often resulted in significant costs and time delays when modifying the system for new products or processes.

In summary, assembly process training and quality assurance relied heavily on manual methods for training, ad hoc quality inspections, and specialized, inflexible machine vision systems for defect detection. These approaches, while functional, were limited in their efficiency, adaptability, and responsiveness to changing manufacturing environments.

### SUMMARY OF THE DISCLOSURE

Rapta Inc., an applied AI software company, has developed the disclosed workstation for enhancing the skills and productivity of workers in user-performed manual dexterity tasks and automated robotic assembly cells while reducing recalls and quality assurance issues across various industries. Features include rapid training of new employees, real-time quality control for manual and automated processes, creation and maintenance of video-based work instructions, and continuous improvement in process control logic. This system is especially valuable in manufacturing environments, providing real-time feedback and upskilling for assembly processes, and is equally applicable in sectors like pharmaceuticals for user-performed manual dexterity tasks such as dispensing and packaging.

Rapta's on-premises AI-enabled embodiments address several significant challenges in industries where precision in manual tasks is critical. The AI-driven system, which operates independently of cloud connections, offers immediate feedback and instructional support, ensuring workers perform tasks accurately and efficiently. This capability is vital in preventing quality issues from occurring on the factory floor. By continuously monitoring the manufacturing process, the system can detect even minor deviations from standard work instructions in real time, significantly reducing the risk of product defects and the need for costly recalls.

In addition to real-time inspecting and feedback, the system provides supervisors with detailed task-level analytics, aiding in the identification of bottlenecks, reduction of human errors, and optimization of production workflows. The AI component can also interface with control systems to manage and adjust the balance of control throughout various processes, further enhancing product quality and consistency.

The system ensures adherence to specific requirements for components like wiring, power electronics, control boards, and mechanical assemblies. By implementing Rapta's system, companies can safeguard their brand reputation by significantly reducing the likelihood of product recalls and quality issues, thereby maintaining high standards of customer satisfaction and trust.

Additional aspects and advantages will be apparent from the following detailed description of embodiments, which proceeds with reference to the accompanying drawings.

### BRIEF DESCRIPTION OF THE DRAWING FIGURES

To easily identify the discussion of any particular element or act, the most significant digit or digits in a reference number refer to the figure number in which that element is first introduced.

FIG. 1 is a perspective view of a workstation system for user-performed manual dexterity tasks in accordance with one embodiment.

FIG. 2 is a perspective view of the workstation system including robotic integration in accordance with one embodiment.

FIG. 3 is a perspective view of a workstation system including an overhead inspection pod assembly that is also shown in an enlarged detail view, in accordance with one embodiment.

FIG. 4 is an enlarged, fragmentary perspective view of the overhead inspection pod assembly of FIG. 3, in accordance with one embodiment.

FIG. 5 is a front elevation of another workstation system showing different mounting positions for one or more inspection pod assemblies, in accordance with one embodiment.

FIG. 6 is a block diagram showing how different applications may be used with different AI models at the workstation system in accordance with one embodiment.

FIG. 7 is a block diagram of a microservices software architecture for the workstation system in accordance with one embodiment.

FIG. 8 is a screenshot of an assembly creation user interface in accordance with one embodiment.

FIG. 9 is a screenshot of an assembly step addition user interface in accordance with one embodiment.

FIG. 10 is a screenshot of an assembly step edit user interface in accordance with one embodiment.

FIG. 11 is a screenshot of an assembly step correct action capture user interface in accordance with one embodiment.

FIG. 12 is a screenshot of an assembly step incorrect action capture user interface in accordance with one embodiment.

FIG. 13 is a screenshot of an assembly step action confirmation user interfaces in accordance with one embodiment.

FIG. 14 is a screenshot of an assembly step action similarity check user interface in accordance with one embodiment.

FIG. 15 is a screenshot of an assembly step description user interface in accordance with one embodiment.

FIG. 16 is a screenshot of an assembly step OCR edit user interface in accordance with one embodiment.

FIG. 17 is a screenshot of a data augmentation user interface in accordance with one embodiment.

FIG. 18 is a screenshot of an operator user interface in accordance with one embodiment.

FIG. 19 is a screenshot of a live inspection user interface in accordance with one embodiment.

FIG. 20 is a screenshot of a live inspection user interface in accordance with one embodiment.

FIG. 21 is a screenshot of a live inspection user interface in accordance with one embodiment.

FIG. 22 is a screenshot of a real-time factory floor information user interface in accordance with one embodiment.

FIG. 23 is a block diagram showing integration with other business software in accordance with one embodiment.

FIG. 24 is a flow chart of a process in accordance with one embodiment.

FIG. 25 is a block diagram of computing components for performing the disclosed processes in accordance with one embodiment.

### DETAILED DESCRIPTION OF EMBODIMENTS

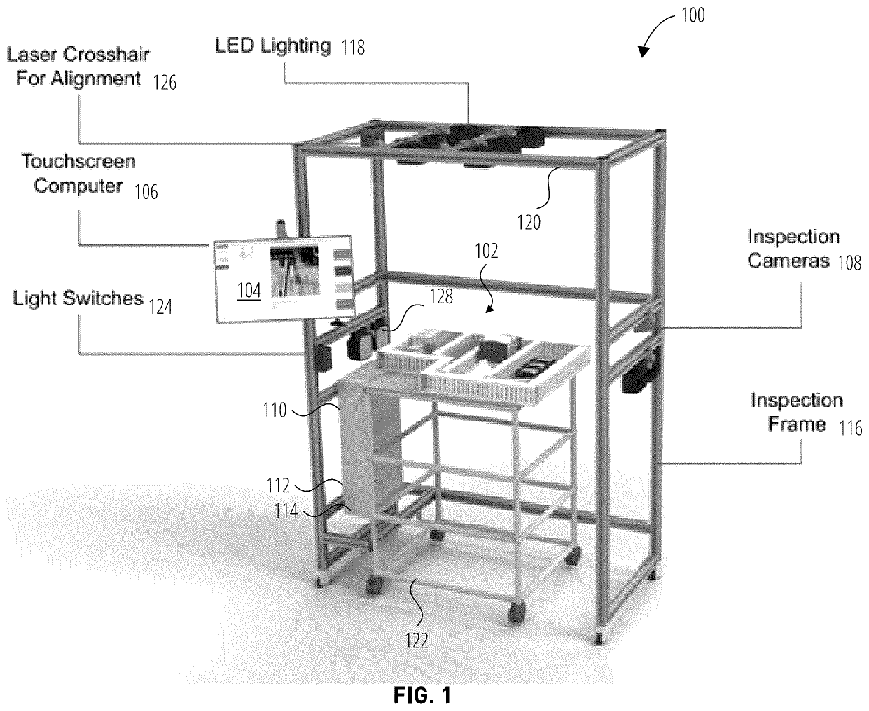

FIG. 1 shows a workstation system 100 (also referred to as the Rapta system) for automated inspection of robotically or manually performed dexterous tasks. The term workstation refers to an area where work of a particular nature is carried out, such as a specific location on a manufacturing assembly line. The phrase robotically or manually performed dexterous task is meant to convey how workstation system 100 is designed for evaluating and monitoring the accuracy, skill, and effectiveness of a robot (i.e., robotic arm) or a person performing precision execution of a piece of work at a user-accessible workstation 102.

Like a manually performed dexterous task, a robotically performed dexterous task entails a level of precision that is analogous to human dexterity (handiwork), but performed by robots, e.g., using robot end effectors or end of arm tooling. Some examples of dexterous tasks include assembling, manipulating, testing and measuring, calibrating, or otherwise working with small components (e.g., items capable of being manipulated by hand). Example components include electro-mechanical parts, pharmaceutical drug prescriptions, packaging, welding pieces, or other such items. Such tasks are performed in many different industries including manufacturing, electronics assembly, pharmaceuticals, or any industry where detailed handiwork is performed. Accordingly, as explained in this disclosure, workstation system 100 ensures in real-time that each task in a sequence meets certain quality standards, accuracy, and efficiency.

The term real-time refers to processing that occurs within a time frame sufficient to provide immediate feedback to a user or to dynamically adjust system operation during active workflows. In this context, real-time feedback is achieved within sub-second latency for most operations.

Real-time user feedback is provided by an interactive software application 104 presented on a touchscreen/HMI 106. For instance, a user, who performs a sequence of user-performed manual dexterity tasks, receives feedback and provides input to touchscreen/HMI 106 via interactive software application 104, which is communicatively coupled to an industrial (power over ethernet (POE) camera 108 (or simply, camera 108) and an AI workstation computing device 110. An example of touchscreen/HMI 106 is a SIMATIC Panel PC available from Siemens AG of Munich, Germany. An example of AI workstation computing device 110 is a SIMATIC IPC 520A Box PC, also available from Siemens. AI workstation computing device 110 is housed in an enclosure 112 that also houses power supplies (e.g., SITOP power supply available from Siemens) and an industrial POE switch 114, such as the SCALANCE XC208G POE (available from Siemens).

In the example of FIG. 1, workstation system 100 also includes several illumination components coupled to an inspection frame 116 such as, for example, LED lighting 118 on a mounting gantry 120 for illuminating user-accessible workstation 102 atop a cart 122 or table, light switches 124, a laser crosshair 126 or other fiducial for alignment, and supplemental indicator lights 128 to provide optional feedback in response to a completed task. Skilled persons will appreciate, based on this disclosure, that many other variants of lighting and workstation structures may be employed.

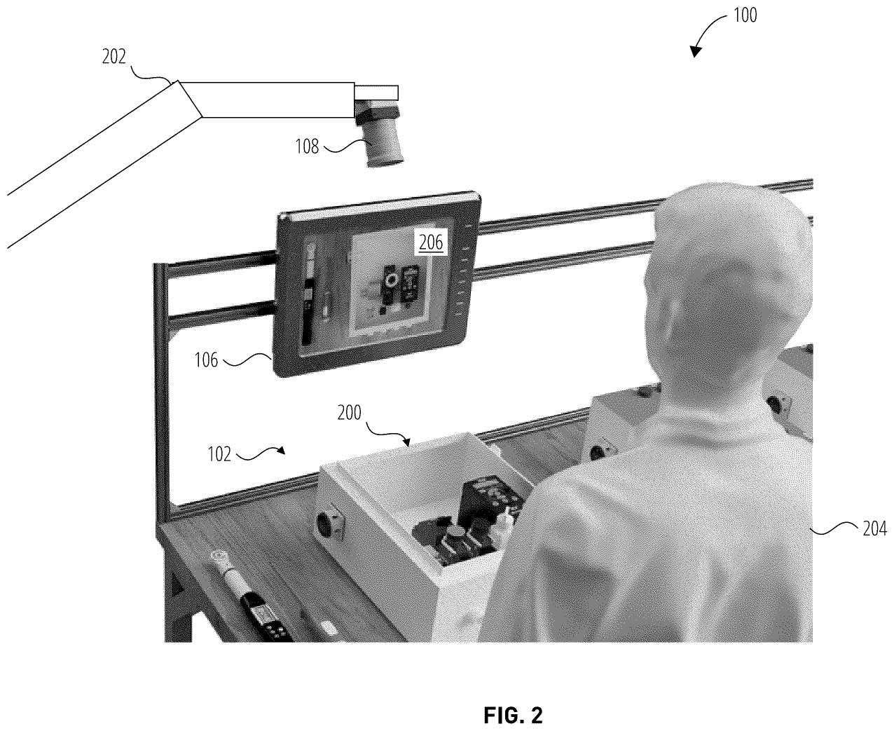

For instance, FIG. 2 shows another example of workstation system 100 that includes robotic integration. In this example, workstation system 100 is configured to inspect the manufacture of an electro-mechanical component 200. Workstation system 100 is similar to system 100 (FIG. 1), but with a different configuration of user-accessible workstation 102, touchscreen/HMI 106, and camera 108. Specifically, camera 108 is deployed at a distal end of a robotic arm 202 to capture video or image data of completed tasks from different inspection locations. Camera 108 is movable because, in this embodiment, some items to inspect would otherwise be occluded by the installed parts.

Preparatory to inspection, a technician 204 trains workstation system 100 using a series of user interface displays 206 so that workstation system 100 is configured to later inspect work during a sequence of user-performed manual dexterity tasks (collectively referred to as “Assemblies” or individually as an “Assembly” in the context of manufacturing). Details for setting up a new assembly are described with reference to the following figures.

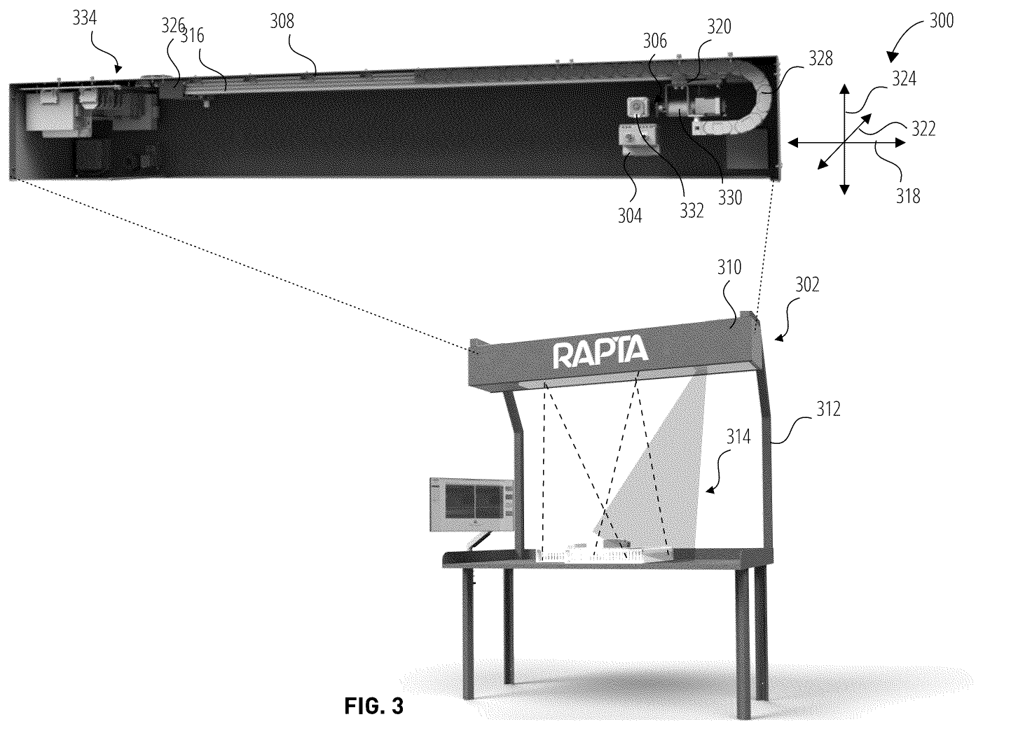

FIG. 3 shows another example of a workstation system 300, which includes an overhead inspection pod assembly 302. Inspection pod assemblies refer to modular units having a camera 304, gimbal system 306, and linear rail 308 within a common housing 310 that can be mounted to an inspection frame 312 or other inspection location. The modular nature of the system allows it to function as a plug-and-play solution that is self-contained and adaptable, capable of rapid deployment over various manufacturing stations without requiring significant reconfiguration or external hardware. For example, the components in a modular unit facilitate repositioning camera 304 relative to a user-accessible workstation 314 so that different fields of view are available during inspection, at high resolution. Optional lighting devices may also be housed within housing 310. Thus, these components provide for a flexible, automated, and multi-axis (multiple degrees of freedom, DOFs) camera positioning system designed to ensure consistent and effective monitoring and QA during the manufacturing process.

During the setup or training phase, an operator manually adjusts the position of camera 304 along linear rail 308 and its orientation using gimbal system 306 to achieve a desired view of a workpiece. These positions are then stored in a database for automated use during actual production or QA tasks, including static or dynamic camera positions enabling further flexibility. Dynamic inspection poses refer to continuous movement of the camera or sensor during an inspection task, allowing for tracking shots or inspections of moving targets, as opposed to static poses, which involve fixed, pre-configured positions. For instance, FIG. 3 shows three fields of view as camera 304 is transported along and by linear rail 308. These positions can be preconfigured, so images are taken at these locations. In other embodiments, a continuous imaging process is used to continuously capture images from different vantage points.

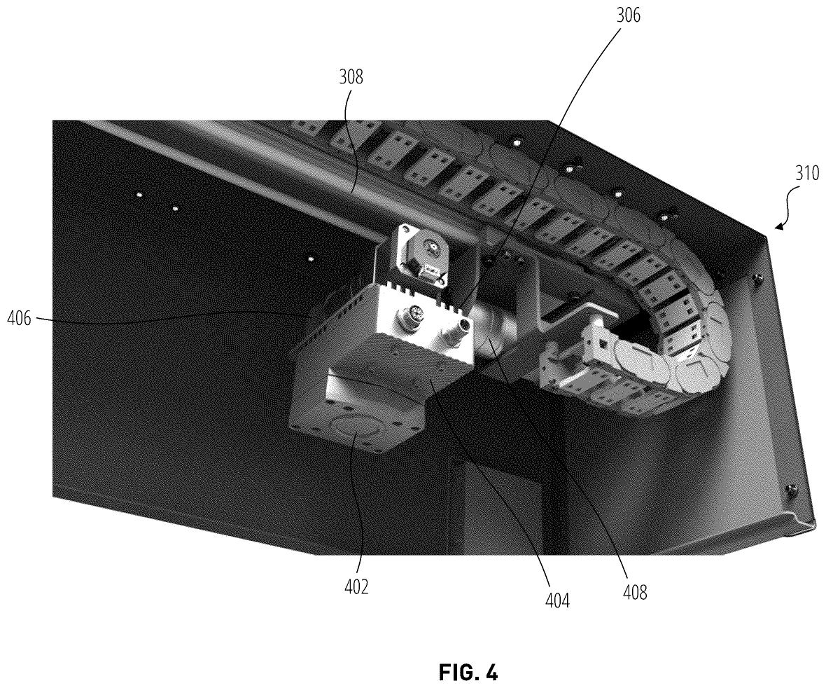

In the upper portion of FIG. 3 and FIG. 4, a detail of housing 310 is shown with its front panel removed to reveal the interior and components. In this view, linear rail 308 can be seen as having a horizontal track 316 along which camera 304 can move in an X axis 318 via a carriage 320 and gimbal system 306. In some embodiments, linear rail 308 allows movement along one or more axes (X axis 318, a Y axis 322, a Z axis 324, or combinations) depending on orientation (horizontal, vertical, or diagonal). Movement along these axes allows camera 304 to be positioned over the inspection target from different angles. The flexibility of the rail lengths allows coverage of larger targets. In some embodiments, a two-axis linear rail may be provided.

Carriage 320 is actuated by a linear rail motor 326. As it moves, a cable management system 328 prevents cables from tangling or getting caught, ensuring smooth and reliable operation of camera 304. In this example, cable management system 328 includes segmented, flexible conduit that protects and organizes cables (not shown).

Gimbal system 306 is a pivoted support that allows rotation of camera 304 around one or more axes (DOFs). This enables camera 304 to be oriented in different directions without moving the entire overhead inspection pod assembly 302, providing flexibility in capturing an inspected workpiece from various angles. In the example of 306, there are two degrees of freedom including pitch/tilt and roll rotation set by, respectively, a pitch gimbal drive 330 and a roll gimbal drive 332. Other examples may also include a yaw/pan adjustment.

Power supply and AI computer 334 include the electronic and computational components that control overhead inspection pod assembly 302. The AI computer processes images and controls the camera positioning, while the power supply provides electricity.

FIG. 4 also shows a lens mount 402 and a GPU/CPU 404 that collectively provide an industrial AI camera, ICAM-520/500 series available from Advantech Co., Ltd., in some embodiments. A first encoder and gearbox 406 for roll gimbal drive 332 and a second encoder and gearbox 408 for pitch gimbal drive 330 are coupled to carriage 320.

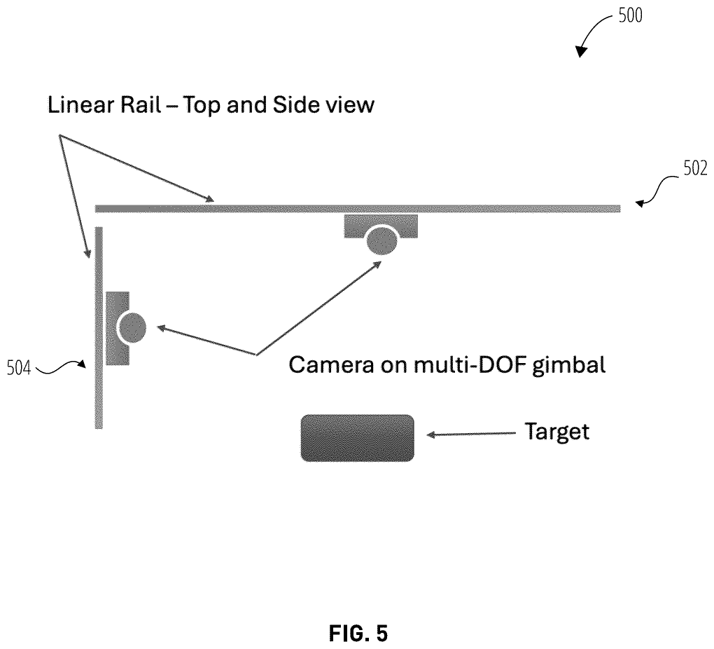

Overhead inspection pod assembly 302 itself can also be deployed at various positions relative to the target (see, e.g., FIG. 5)—above, at an angle, or from the side—depending on the needs of the task. FIG. 5 shows another example workstation system 500. In this example workstation system 500 includes one or both of an overhead inspection pod assembly 502 and a lateral inspection pod assembly 504. Since they are available as modular kits with self-contained computing, camera adjustment, and optional lighting features, one or more units can be rapidly deployed at various inspection stations, including pre-existing manufacturing locations. For example, an entire housing (or subassembly thereof) can be mounted inside a cylinder for inspecting the inner surfaces (e.g., pipe inspection) as the camera dynamically moves along the axis of the cylinder.

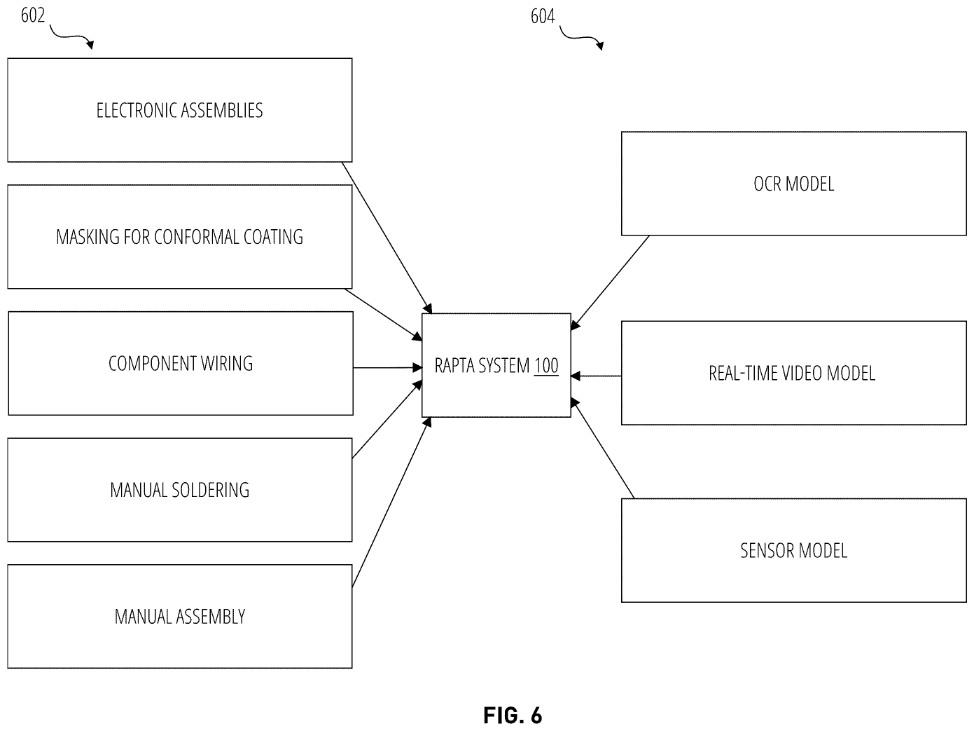

FIG. 6 shows, in the form a block diagram, how workstation system 100 is able to learn new manufacturing assemblies for different types of applications 602 such as electronic assemblies, masking for conformal coating, component wiring, manual soldering, manual assembly, and many other types of applications. By intuitively coordinating different types of AI models 604 (which are automatically deployed and sequenced as a set based on each type of task), Rapta's highly configurable AI platform automates the deployment of AI models 604 for inspection, training and process control.

The term model in the context of AI models 604 refers to a specific computational structure or algorithm, such as a neural network or machine learning algorithm, trained on datasets to identify patterns, make predictions or decision, or perform or carry out specific tasks based on input data. It is a representation of what the AI has learned from its training data, encapsulating the patterns, relationships, and parameters it has identified. In some embodiments, AI models 604 are developed through a process known as machine learning, where they are trained on datasets to learn patterns, relationships, and rules. There are various types of AI models, each suited for different tasks. In this context, AI model includes supervised learning models, unsupervised learning models, reinforcement learning models, and deep learning models, among others. These models may be implemented as software or hardware-accelerated processes, capable of handling a variety of sensor modalities (i.e., the type or nature of data collected by a sensor), including video, text, and time-series data.

Supervised learning models are trained on labeled data, where the desired output is known. They are used for tasks like classification (e.g., categorizing emails into spam or not spam) and regression (e.g., predicting house prices).

Unsupervised learning models work with unlabeled data and are used to find hidden patterns or intrinsic structures in the data. Common applications include clustering (e.g., customer segmentation) and dimensionality reduction (e.g., reducing the number of variables in a dataset).

Semi-supervised and self-supervised learning model are trained on a mix of labeled and unlabeled data, or they generate their own labels from the data. They are useful in scenarios where acquiring labeled data is costly or impractical.

Reinforcement learning models learn by interacting with an environment and receiving feedback in the form of rewards or penalties. They are often used in gaming, robotics, and navigation tasks.

Deep learning models are a subset of machine learning, these models use neural networks with multiple layers (deep networks) to learn complex patterns. They are particularly effective for tasks like image and speech recognition.

The term AI platform in the context of multiple models, refers to an integrated environment or framework that supports the development, training, deployment, and management of multiple AI models. In some embodiments, the platform enables the coordination of AI models with sensor inputs and user interactions to deliver real-time feedback and automation for manufacturing processes. AI platforms are designed to streamline and simplify the process of working with AI, providing tools and services that cover various AI models. An AI platform may include features for data preprocessing, model building, training, evaluation, deployment, and monitoring.

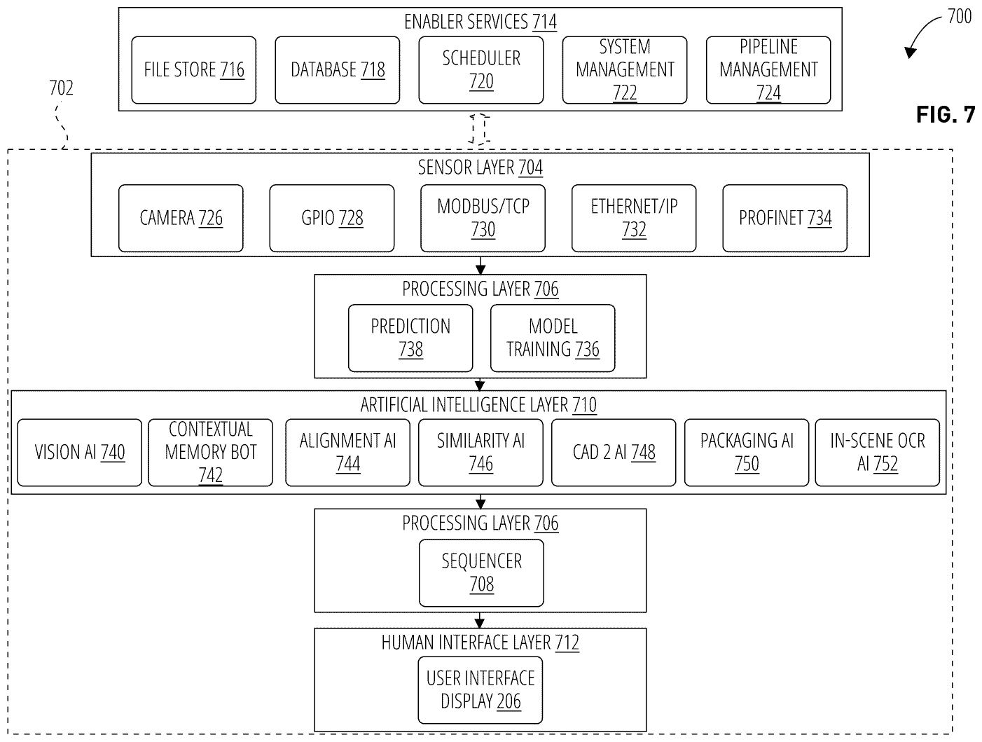

FIG. 7 shows a microservices software architecture 700 for workstation system 100. In general, microservices software architecture 700 leverages convolutional neural networks (CNNs), proprietary deep learning models, and processing techniques to provide a flexible inspection solution that frees end users from developing ad hoc proprietary code and deploying application-specific hardware. As described in more detail below, an AI platform 702 replicates how sensors such as the human eyes, ears, and brain work together to enable AI models 604 to understand a diverse set of applications 602 (FIG. 6). AI platform 702 includes a sensor layer 704, a processing layer 706 (with two phases, i.e., a sequencer 708), an artificial intelligence layer 710, and a human interface layer 712.

Initially, microservices software architecture 700 includes several enabler services 714 that allow it to store, transact and schedule data flow within workstation system 100. In the example of FIG. 7, enabler services 714 include a file store 716, a database 718, a scheduler 720, system management 722, and pipeline management 724.

File store 716 is responsible for storing and serving files to other services in workstation system 100.

Database 718 is responsible for storing the assembly data structure including steps, benchmark time, step type and assembly records capturing performance.

Scheduler 720 is responsible for building assemblies the user has scheduled and for dispatching activity reports according to user defined preferences for reporting. For instance, the assembly may be run overnight to train the models.

System management 722 is responsible for monitoring system health and capturing internal system performance metrics.

Pipeline management 724 is a service that manages the machine learning (ML) Ops pipeline that propagates properly formatted data through components of workstation system 100.

Next, sensor layer 704 collects data from a variety of sources including video and sensors in a user's facility. This enables AI platform 702 to make human-level accurate decisions based on a number of application appropriate sensor inputs. In the example of FIG. 7, sensor layer 704 includes camera 726, GPIO 728, MODBUS/TCP 730, Ethernet/IP 732, and Profinet 734.

Camera 726 is the service that interfaces with one or more cameras (industrial PoE camera 108, FIG. 1 and FIG. 2) to capture data at a prescribed resolution and framerate, mange connection health, reconnect if the connection is lost, and update camera 108 with the latest configuration settings.

GPIO 728 is the service responsible for interfacing with the inputs and outputs of computer(s) and provides a hardware abstraction layer in place for managing events such as the capture of rising signal edges, falling signal edges, or other input events, and the generation of output events.

MODBUS/TCP 730 is the service responsible for providing a generic API between the implementation-specific Modbus standard and the Rapta services API. This service 730 includes any additional event management including responding to traffic on the bus, providing any subscribed updates, and managing the connection and disconnection of other devices.

Ethernet/IP 732 is the service responsible for providing a generic API between the implementation-specific Ethernet IP standard and the Rapta services API. This service includes any additional event management including responding to traffic on the bus, providing any subscribed updates and managing the connection and disconnection of other devices.

Profinet 734 is the service responsible for providing a generic API between the implementation-specific Profinet standard and the Rapta services API. This service includes any additional event management including responding to traffic on the bus, providing any subscribed updates and managing the connection and disconnection of other devices.

Next, processing layer 706 includes a model (assembly) training 736 service and a prediction 738 service that ingests data and passes it to the proper (i.e., task-specific) set of AI models in artificial intelligence layer 710.

Prediction 738 service is the service that processes the predictions from artificial intelligence layer 710 and passes them to sequencer 708.

Model training 736 service interacts with artificial intelligence layer 710 and human interface layer 712 to interface the human interface and thereby assist the user to create and maintain assemblies.

FIG. 7 then shows that artificial intelligence layer 710 includes different AI models to process the incoming data and provide their output to sequencer 708. In the example of FIG. 7, artificial intelligence layer 710 includes a vision AI model 740, a contextual memory bot model 742, an alignment AI model 744, a similarity AI model 746, a CAD 2 AI model 748, a packaging AI model 750, and an in-scene OCR AI model 752. Other AI models are also possible. For instance, a sensor value AI (see, e.g., sensor model in FIG. 6) receives readings from various sensors (e.g., multimeter or torque wrench sensors) to determine whether the readings are within specifications.

Vision AI model 740 is a deep learning neural network that can learn and QA nearly any mechanical assembly process.

Contextual memory bot model 742 is a neural network that turns human speech into a textual interface to enable the computer to understand human commands.

Alignment AI model 744 is a neural network that can align the camera to objects within the scene.

Similarity AI model 746 is a neural network that detects if images captured by the user in the training service are too similar and will result in degraded system performance as a result of AI training data confusion.

CAD 2 AI model 748 is a neural network that can read electrical CAD drawings and create synthetic training data for services of workstation system 100.

Packaging AI model 750 is a neural network that understands the packaging process in manufacturing and can provide real-time feedback to the user.

In-scene OCR AI model 752 is a deep learning neural network that can convert complex written text into machine readable text strings for comparison and matching purposes.

Within sequencer 708 is where correct AI models are selected and weighted for the specific step of the assembly. The weights create varying gain functions and enable workstation system 100 to utilize the optimal AI model(s) for the specific assembly action, much like a human uses multiple senses to determine where a ball drops in front of them. The term actions, with respect to workstation system 100, encompasses orchestrating models but also encapsulating a confluence of sensors (such as physical/electrical, vision, audio, etc.) as an action-specific selection so that a user can select the action to automatically connect the appropriate underlying sensors to processing resources, which may encompass AI model processing or heuristic processing. A gain function, as used herein, refers to a mathematical weighting mechanism applied to the outputs of one or more AI models to produce a cumulative result for decision-making. For example, a gain function may weigh results from a vision AI model and a time-series AI model to assess the accuracy of a completed task.

Finally, human interface layer 712 provides an interactive visual interface to workstation system 100 for the user.

A working example of AI platform 702 is an action to torque a bolt tight. In this example, sequencer 708 orchestrates vision AI model 740 to verify the torque wrench is placed on the right bolt while a sensor (i.e., torque) AI model verifies time-series measurement data from sensor layer 704 to ensure the torque event occurred on a time-synchronized basis (i.e., time-synchronized with the video data). Sequencer 708 applies a gain function to the results from vision AI model 740 and the sensor AI model to reach a consensus determination in terms of whether the action to torque a bolt is within the trained system parameters.

Another working example is vision AI model 740 and in-scene OCR AI model 752 are orchestrated by sequencer 708 to validate a correct component has been installed in the proper orientation within an electrical circuit. In-scene OCR AI model 752 reads text from the component to validate it is the correct part while vision AI model 740 validates the correct physical placement and orientation.

Orchestration of multiple models has shown to result in a robust inspection system. In contrast to the above-mentioned examples, use of a single model (in isolation) could easily be compromised by inadvertent or deliberate human error, potentially leading to a quality assurance issue.

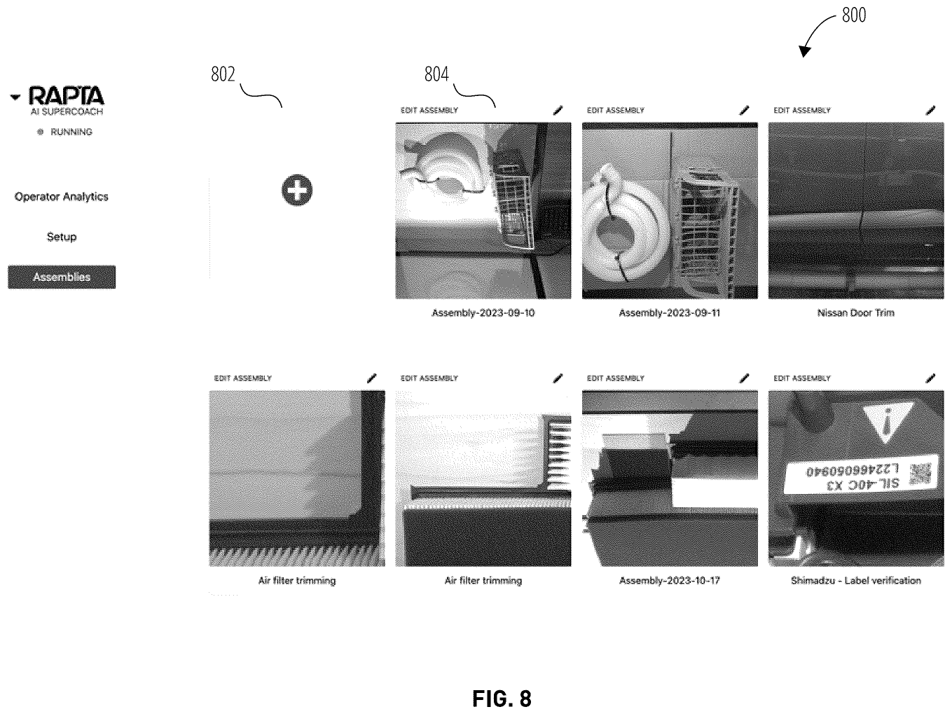

FIG. 8 shows an assembly creation user interface 800 presented on touchscreen/HMI 106 (FIG. 2) for creating and editing different assemblies. Assembly creation user interface 800 guides a user (e.g., technician 204, FIG. 2) through a process for creation of an assembly including one or multiple step processes. The user initiates creation of a new assembly by selecting an add assembly card 802. The user can edit an existing assembly by selecting an edit assembly card 804 near its pencil icon.

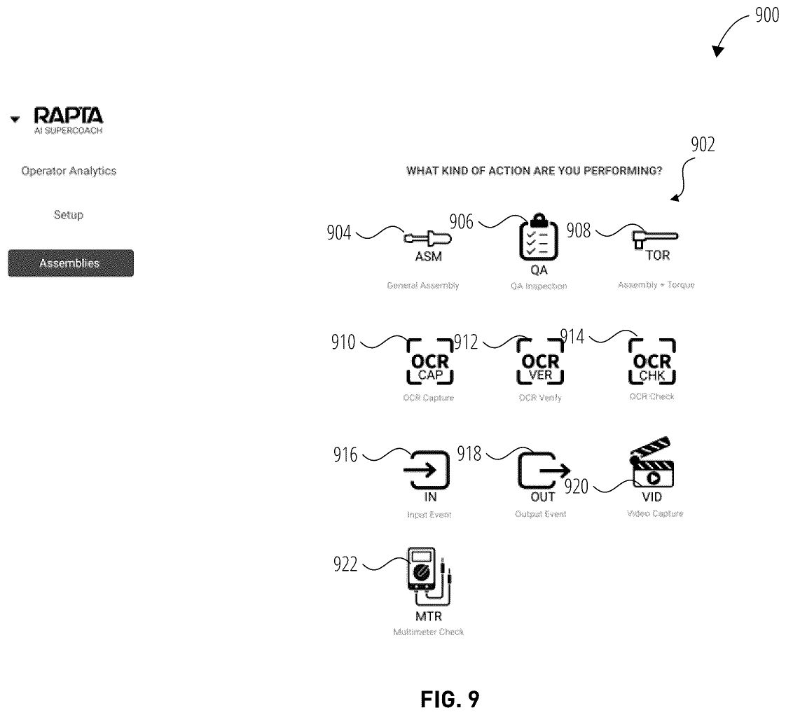

In response to selecting add assembly card 802, FIG. 9 shows that the user is presented an assembly step addition user interface 900 displaying a set of step-specific actions 902. Step-specific actions 902 include tasks performed by a user as well as system triggers or events received by or provided from workstation system 100.

The actions available to configure on assembly step addition user interface 900 include a general assembly action 904, a QA inspection action 906, an assembly and torque action 908, an OCR capture action 910, an OCR verify action 912, an OCR check action 914, an input event action 916, an output event action 918, a video capture action 920, and a multimeter check action 922. Skilled persons will appreciate in light of this disclosure that other embodiments may include a different set of actions. Some embodiments employ one AI model per assembly; however, other embodiments may employ a different trained instance of an AI model per step (e.g., a different trained instance of vision AI model 740 for each step).

Each member of set of step-specific actions 902 represents a new assembly step and instructs a sequencer (described previously with reference to FIG. 7) to orchestrate AI models (FIG. 7) corresponding to that particular step. The orchestration may entail providing sensor data to a corresponding AI model, or otherwise triggering an AI model. For instance, digital inputs are used by the torque AI model. This selection process is intuitive for users and eliminates the need for data scientists. Instead, users select an action to perform so that AI platform 702 (FIG. 7) will automatically select and enable the appropriate task-specific AI model(s) for processing a corresponding sensor modality input for the step.

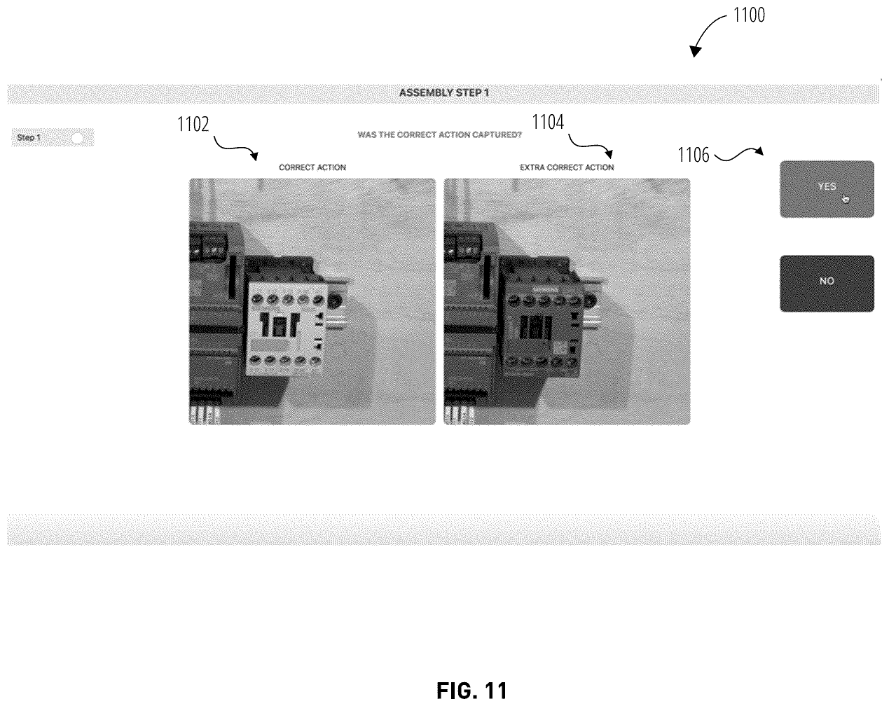

General assembly action 904 enables vision AI model 740 to capture the start and the end of the step. Examples of the training process for general assembly action 904 are described later with reference to FIG. 11-FIG. 14. Once trained, at inspection time sequencer 708 engages a gain function to verify if the user has completed the current step successfully. The gain function, for example, weighs (e.g., from zero to one) results of multiple models to assess the cumulative result.

If the expected AI model prediction is received, then the user will pass onto the next step, otherwise, workstation system 100 remains step-locked to the current step. If the incorrect prediction for that step is received, then the user will be displayed instructions on rectifying that incorrect mistake and one or both a visual and audible warning that they have made a mistake. In this example, the corresponding sensor modality input is the live-video (or image) data showing the user's work at user-accessible workstation 102.

QA inspection action 906 enables vision AI model 740 that sequencer 708 uses to verify the end of step state on a pass/fail basis. The step will automatically transition to the next step once the sequencer with gain function determines whether a pass or fail label has been received. Unlike general assembly action 904, the user is not step locked. In this example, the corresponding sensor modality input is the live-video (or image) data showing the user's work at user-accessible workstation 102.

Assembly and torque action 908 enables vision AI model 740 and a time-series AI torque model (see, e.g., sensor model in FIG. 6) and applies weights to the gain functions to determine when the step is completed. If sequencer 708 detects an incorrect sequence of events, then it will prevent the user proceeding to the next step and workstation system 100 remains step locked to the current step. Incorrect step sequences include vision AI model 740 detecting the torque tool is not correctly installed, on the wrong fastener or the torque event did not occur when the torque wrench was on the correct fastener.

OCR capture action 910 enables in-scene OCR AI model 752 for sequencer 708 gain functions to capture a specific text string such as a serial number, product model number, or other notable string from a specific location within the visual range of camera 108. The captured string can then be used in conjunction with an OCR check action 914, explained below.

OCR verify action 912 is selected when the user wants to verify that components within their manufacturing process match the original article. This step-specific action therefore orchestrates gain functions to enable in-scene OCR AI model 752 and vision AI model 740 to verify correct text strings in the assembly.

OCR check action 914 enables in-scene OCR AI model 752 in sequencer 708 to use OCR captured text string to compare against prior steps using OCR capture action 910 for that string designator. This enables workstation system 100 to read a serial number off a surface then verify the same serial number is present in other user-designated locations observable by camera 108.

Input event action 916 enables sequencer 708 to wait for an input event from the digital inputs (e.g., GPIO 728) or programmatic interfaces that would then start or continue the assembly workflow when that specific event is received. An example is when robotic arm 202 (FIG. 2) communicates an electrical signal input trigger indicating that robotic arm 202 is positioned and ready for Rapta system 100 to perform the next action (e.g., QA inspection action 906).

Output event action 918 directs sequencer 708 to provide the result from sequencer 708 to a specific digital output (e.g., GPIO 728) or programmatic interfaces. This enables the result of a sequence of actions to be returned to a higher-level control system such as PLC, MES, or ERP, or another user notification such as illumination of indicator light 128 (FIG. 1).

Video capture action 920 does not engage AI models as sequencer 708 captures the video action then displays this video to the user as a time bound instructional step.

Multimeter check action 922 enables vision AI model 740 plus a time-series (i.e., sensor) AI model and applies weights to the gain functions to determine when the step is completed. If sequencer 708 detects an incorrect sequence of events, then it will prevent the user proceeding to the next step and workstation system 100 remains step locked to the current step. Incorrect step sequences include vision AI model 740 detecting the multimeter probes are not correctly placed, in the wrong location, or the multimeter measurement or event did not occur when the multimeter probes were correctly placed.

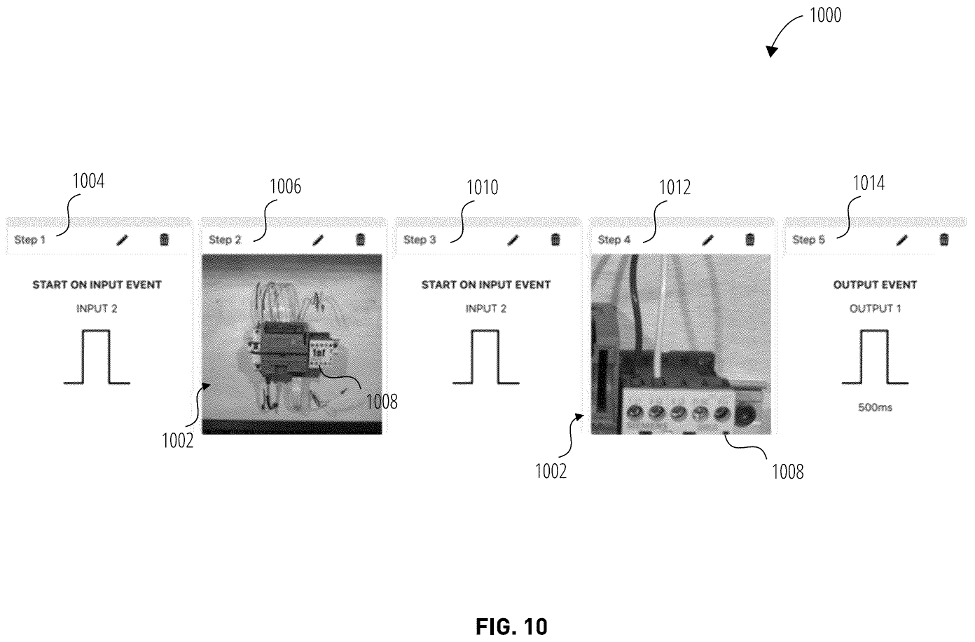

FIG. 10 shows an assembly step edit user interface 1000 that includes a sequence of five actions previously added from assembly step addition user interface 900. In this example, the five actions are for an assembly (i.e., wiring) a PLC 1002.

Input trigger event 1004 is a configured instance of input event action 916 (FIG. 9). Thus, input trigger event 1004, either a digital input (e.g., GPIO 728) or programmatic interface (e.g., MODBUS/TCP 730, Ethernet/IP 732, or Profinet 734), will start the assembly task upon receipt of that trigger.

General assembly action 1006 is a configured instance of general assembly action 904 (FIG. 9) that invokes vision AI model 740 for correct installation of an electrical component 1008.

Input trigger event 1010 is another configured instance of input event action 916. In this instance, the running assembly task is paused until the trigger event occurs.

QA event 1012 is a configured instance of QA inspection action 906 (FIG. 9). This QA event 1012 verifies correct wiring orientation (e.g., labels up), locations, and color.

Output event 1014 is a configured instance of output event action 918 (FIG. 9). Output event 1014 will notify the user of the result of QA event 1012 by either a digital output (e.g., GPIO 728) or programmatic interface (e.g., MODBUS/TCP 730, Ethernet/IP 732, or Profinet 734).

FIG. 11 is assembly step correct action capture user interface 1100 showing an example of the action builder for general assembly action 904. In assembly step correct action capture user interface 1100, the user initiates a capture showing an example of a correct assembly step action 1102. Optional alternative correct assembly step actions 1104 may also be captured in front of camera 108. Multiple correct parts are often specified for a system to enable multi-vendor sourcing. Workstation system 100 then presented to the user confirmation inputs 1106 to positively confirm each image before it is added to the library of labelled images for that step.

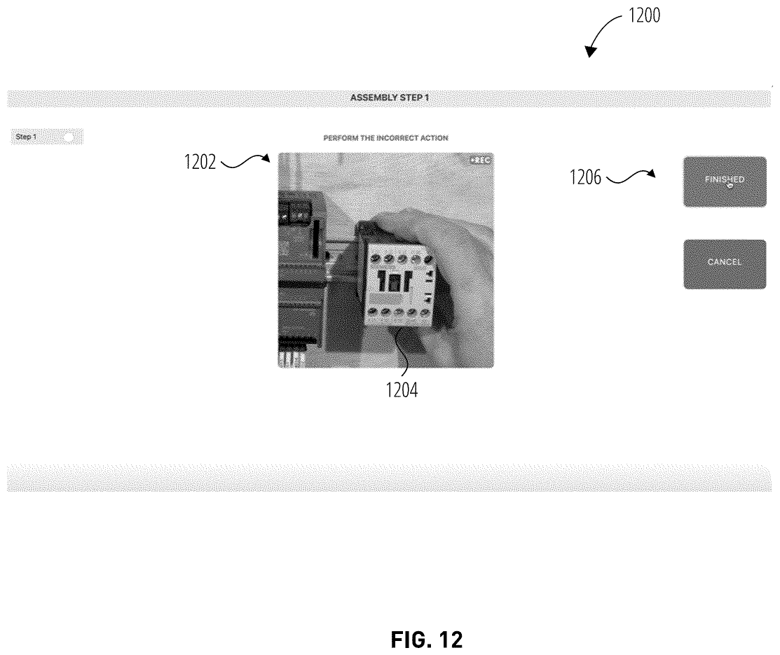

FIG. 12 an assembly step incorrect action capture user interface 1200. This shows how a user initiates the capture of an incorrect assembly action 1202. In this example, electrical component 1204 is improperly spaced. The user performs incorrect assembly action 1202 and then positively confirms when complete by selecting finished input 1206. Examples of incorrect steps are used to generalize the model and catch common mistakes known to the customer, thereby capturing key tribal knowledge off the factory floor.

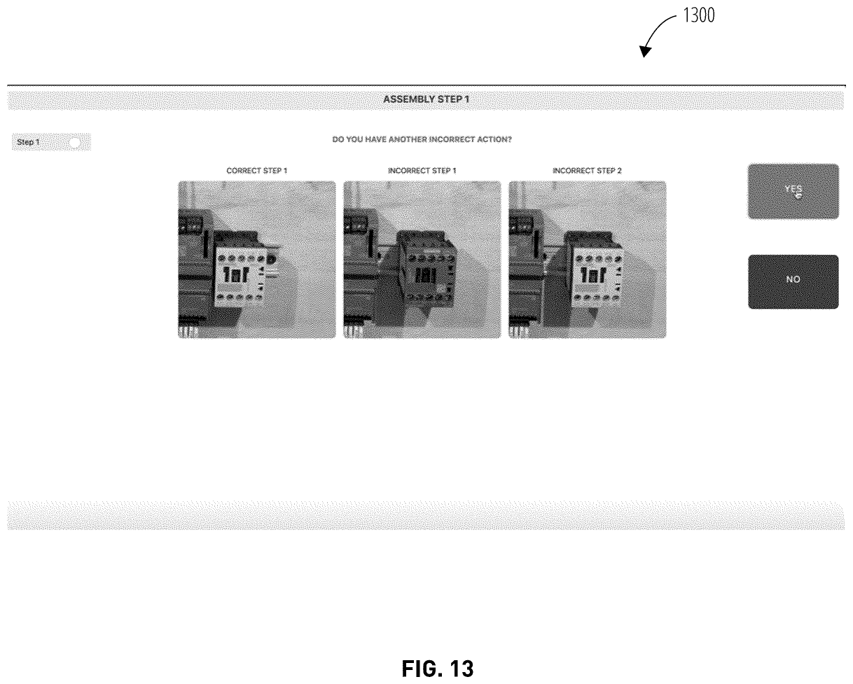

Next, FIG. 13 shows that, once correct and incorrect actions are completed, they are presented as a visual library in an assembly step action gallery on user interface 1300. Here, the user may confirm their work and elect if they wish to add another incorrect action.

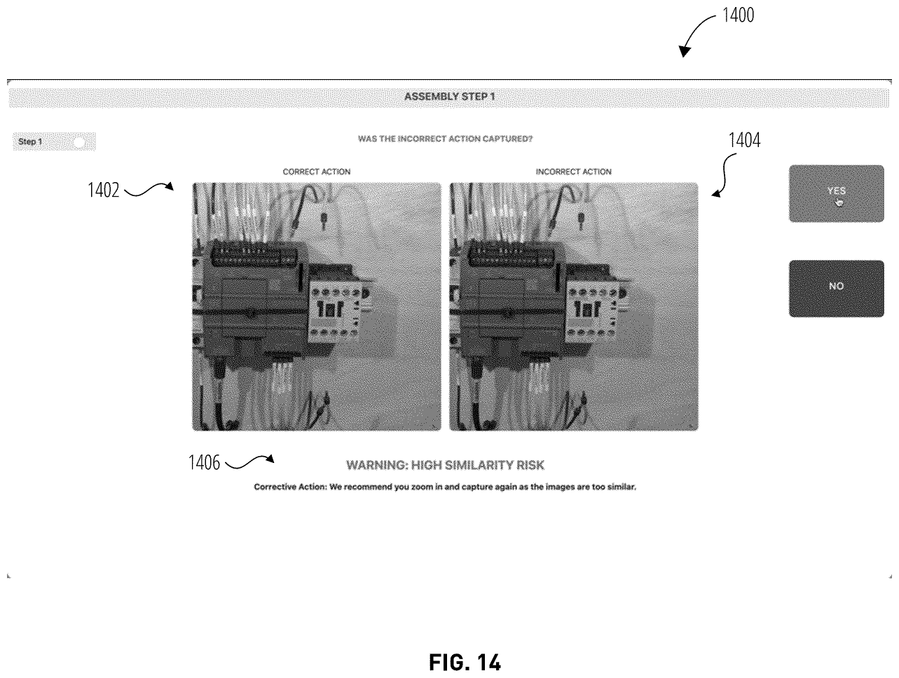

FIG. 14 shows an example of an assembly step action similarity check on user interface 1400. During the assembly creation process, similarity AI model 746 runs continuously as a background engine to check the quality of the data captured. In each step, a correct step image 1402 is checked against incorrect step image 1404 examples provided by the user. If there is a data collection error by the user, then similarity AI model 746 will display a warning 1406 to the user to guard against data corruption in the AI model(s) that correspond to the action.

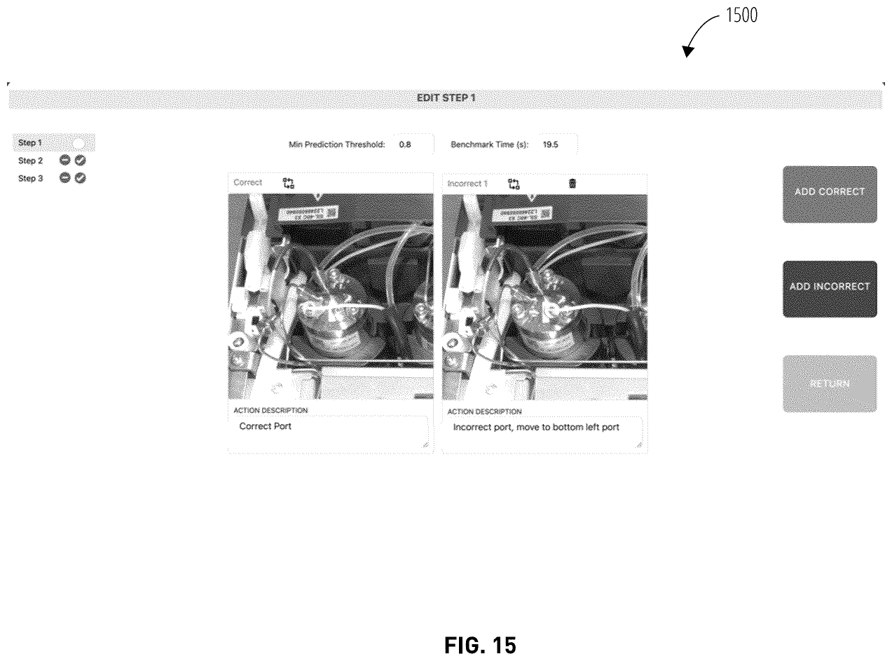

FIG. 15 shows that, in an assembly step description user interface 1500, the user can optionally annotate correct and incorrect step images with step descriptions for explaining to the user (during inspection) the examples in the assembly data set. This enables workstation system 100 to be prescriptive and provide specific instructions to the user on remediation for the error they have introduced.

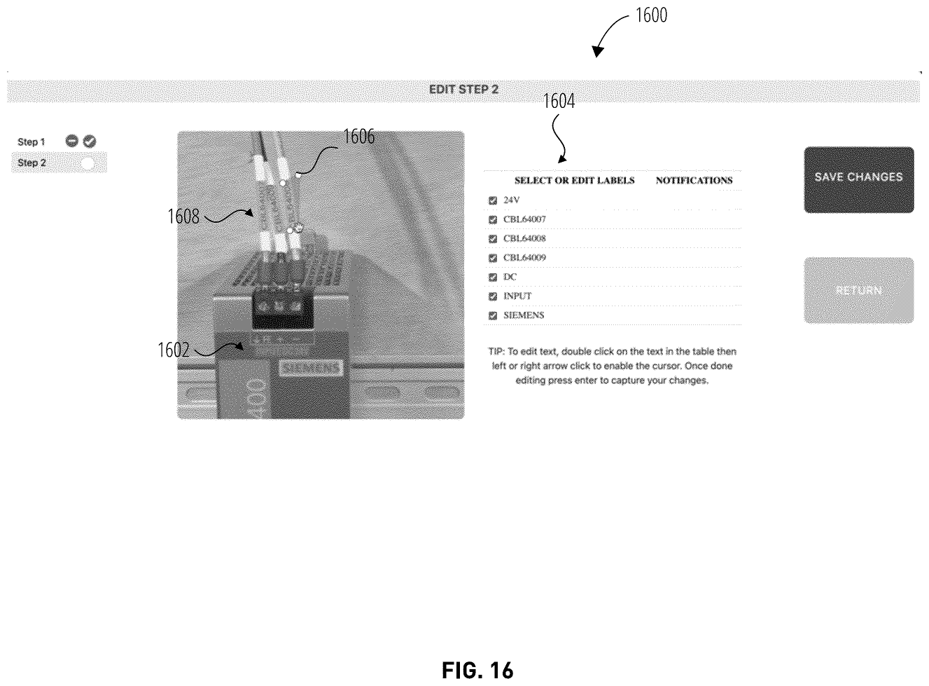

FIG. 16 provides an example of an assembly step OCR edit user interface 1600, which enables the user to capture and verify text strings on a variety of surfaces including wire (1103) and component 1602 labels, box labels, compliance labels, and other items. During the assembly creation process, the user runs an OCR capture action 910 that captures all text in the scene and provides the user a visual editor to validate 1604 the text and locations for copy exact manufacturing. Bounding box corners 1606 can be edited now or later to change the size of the OCR text box so that, if large placement variance is expected, workstation system 100 can accommodate that variance during production.

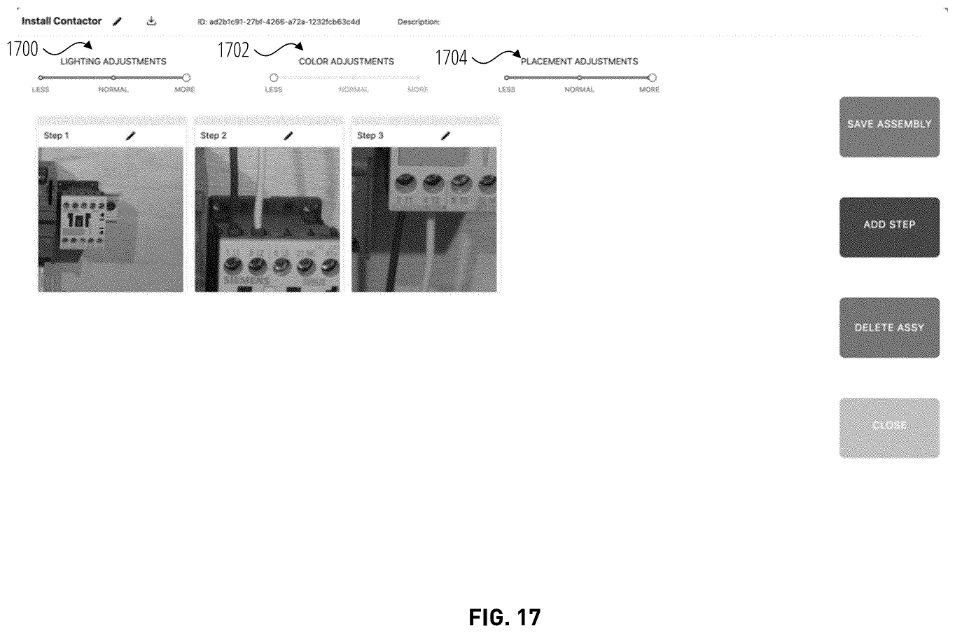

FIG. 17 shows that, once the assembly has been created, the user has the option to adjust the data augmentation templates through the visual sliders. Lighting adjustments 1700 enable variance for different lighting conditions such as color temperature, brightness, contrast, etc. Color adjustments 1702 enable for scene color variances from painted surfaces that may differ from part to part. Placement adjustments 1704 provide accommodation for component placement tolerance.

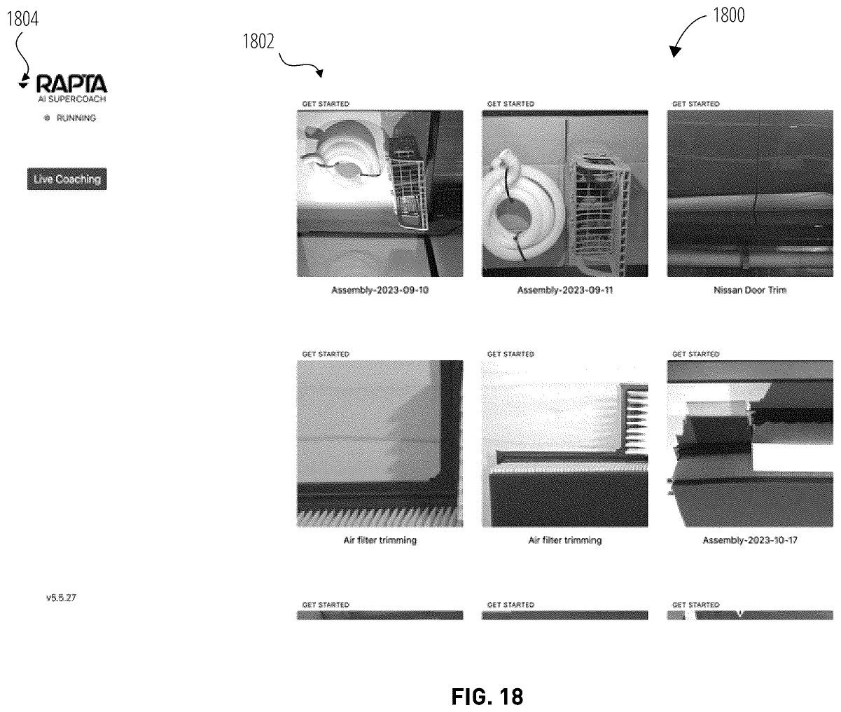

FIG. 18 shows an operator user interface 1800 that enables the customer to launch different assembly or QA jobs by selecting a job card 1802. On the top left, the user can navigate an operational menu 1804 to go from operator to supervisor mode.

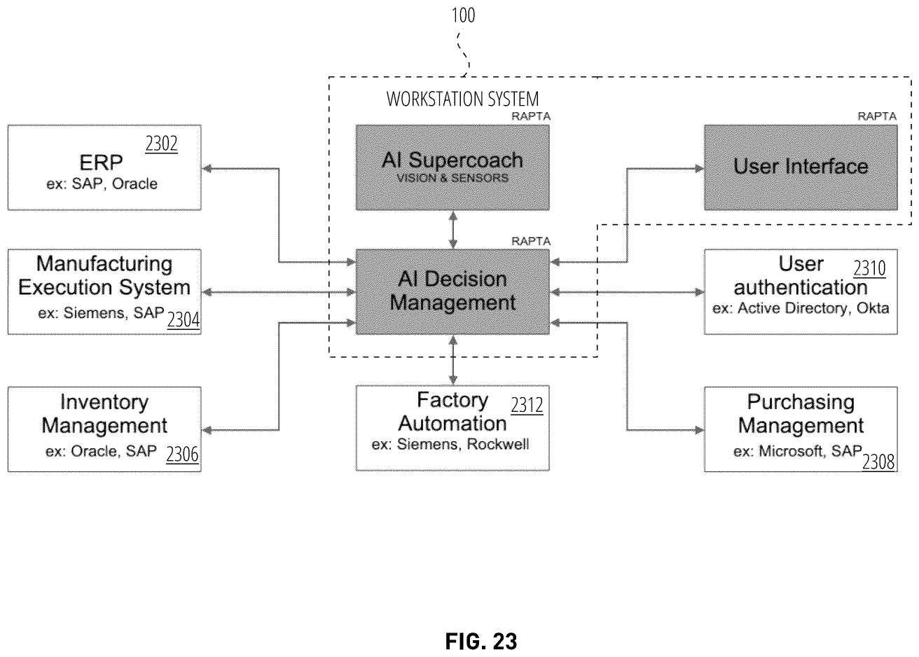

During the job, AI platform 702 delivers continuous training and quality assurance in real time ensuring work is being completed correctly, which is referred to as an AI supervisor, AI inspector, or AI supercoach. The AI supervisor delivers continuous improvement control over an automated process. It can also monitor high speed applications and shut down a control system when errors occur (see, e.g., FIG. 23 showing integration with other systems). Control system inhibits can be realized based on what the vision knows to be incorrect. Wiring and component hardware checkouts can be completed extremely fast and training the AI Supervisor for this task is done with Excel and CAD file ingest.

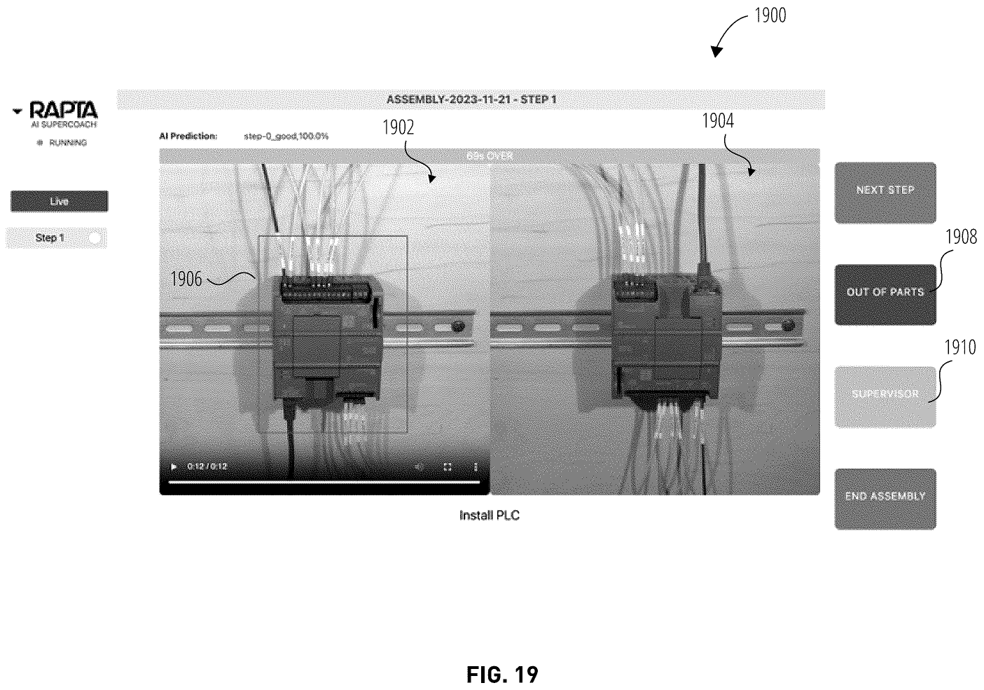

FIG. 19 shows a live inspection user interface 1900. This screen shows the user has launched an assembly job with video instruction 1902 for the user and a live video feed 1904. If the user makes a mistake, the interface will strobe a red indicator box 1906 and sound a warning sound. The user has options to page the supervisor with button 1908 and notify they are out of parts with button 1910.

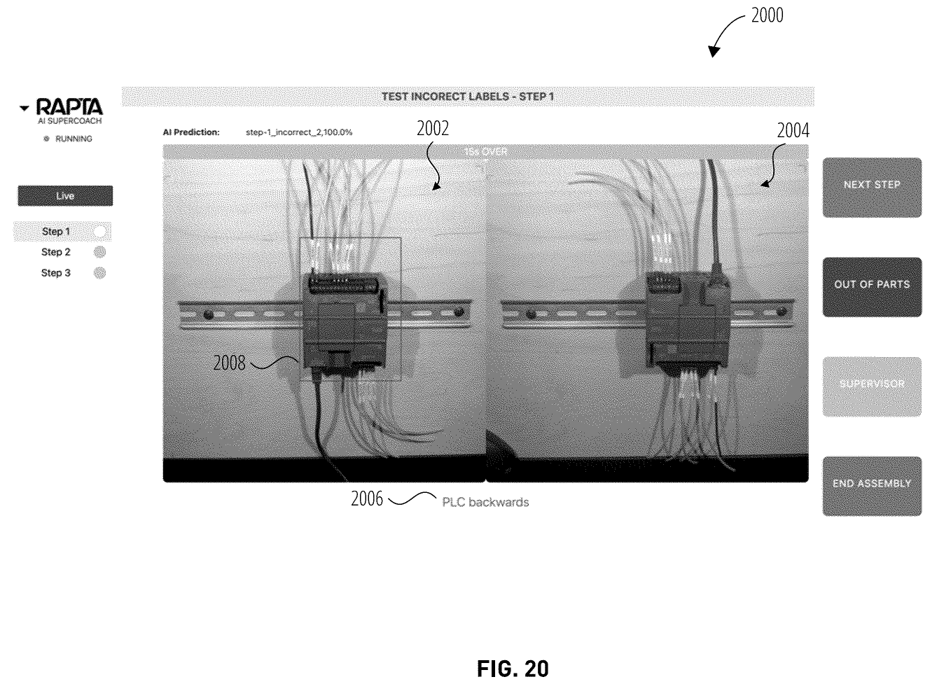

FIG. 20 shows another live inspection user interface 2000 in which the correct action is shown as a video 2002 and a live video feed 2004 is provided for the user action. In the event an incorrect action is detected, workstation system 100 will provide error notifications with an error message 2006 and strobe a red bounding box 2008 around the part to highlight the defect in the assembly to be remediated before system 100 will proceed to the next step.

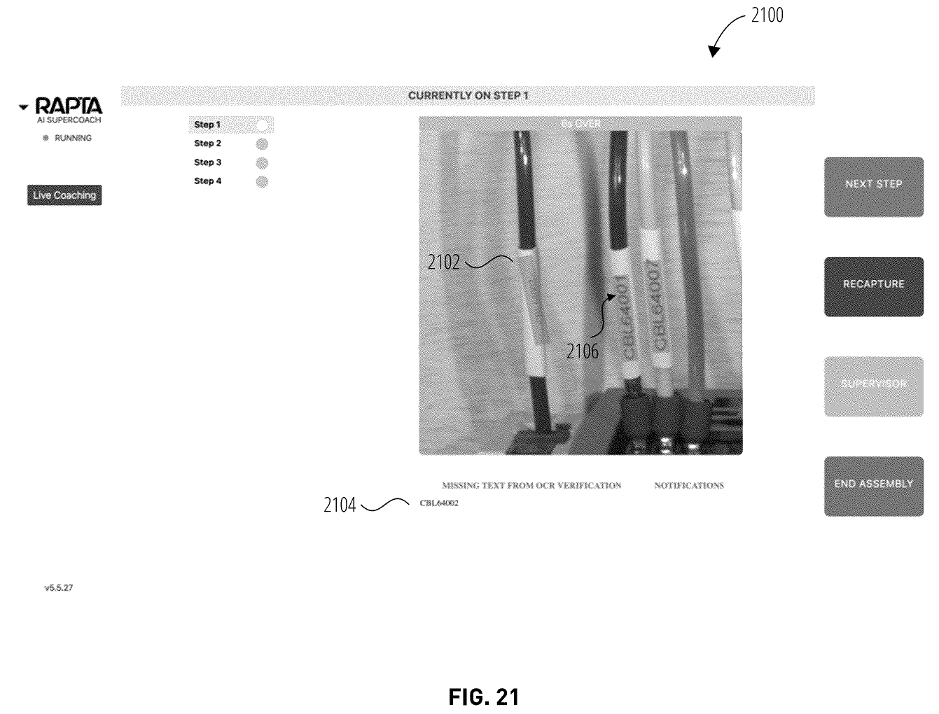

FIG. 21 is another live inspection user interface 2100. This screen shows the system detected a missing wire label 2102 and notifies the user of expected wire designator 2104. Verified wire labels 2106 are shown in green to confirm these are correct.

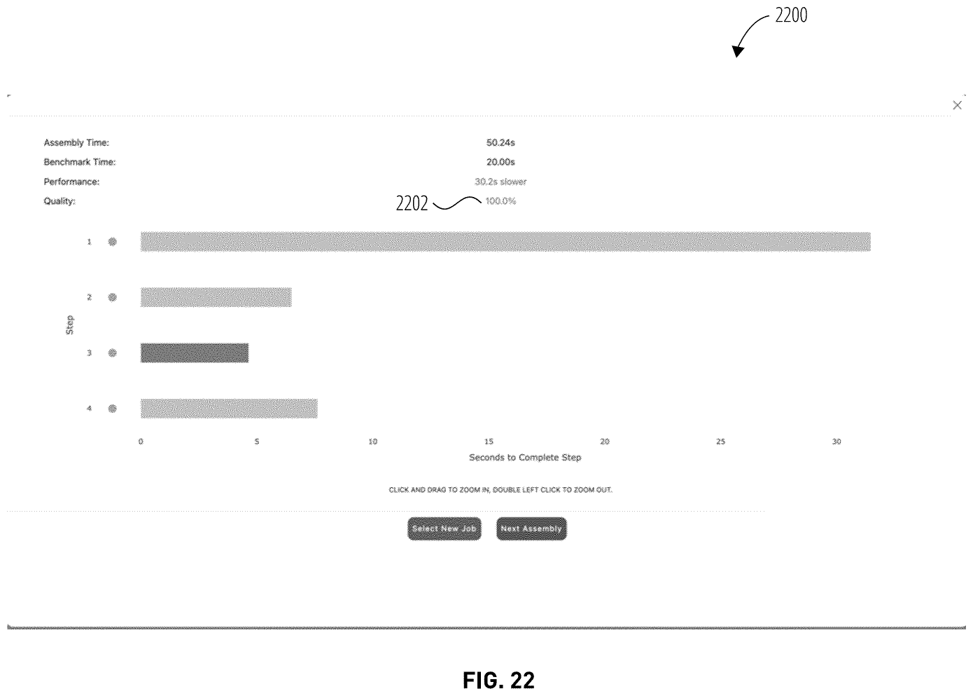

FIG. 22 shows a real-time factory floor information user interface 2200 on operator performance. In this example, information is reported for each step displayed once the job is complete. This report shows whether each step is above or below the benchmark time established during assembly creation (or user defined) and whether there were any defects in quality 2202.

FIG. 23 shows workstation system 100 may be deployed on premises and integrated with other business software. Workstation system 100 contains programmatic interfaces for connecting it to other enterprise software tools. Enterprise resource planning (ERP) 2302 tools, MES 2304, inventory management 2306, and purchasing management 2308 have a host of application programmatic interfaces (API) including but not limited to Restful API's, SOAP APIs, GraphQL endpoints. The API service on workstation system 100 enables an authorized user to interact with the system to programmatically exchange data. User authentication 2310 services may use LDAP or Active Director to transact. Factory automation 2312 systems use different programmatic interfaces such as EthernetIP, ModbusTCP, Profinet and many more and there provide communication interfaces with workstation system 100.

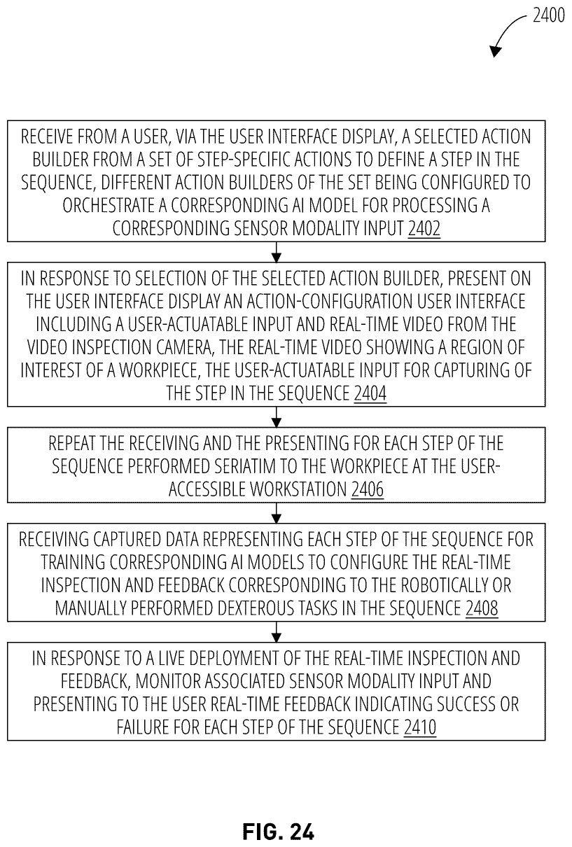

FIG. 24 shows process 2400, performed by a workstation system, for automating deployment of AI models 604 (FIG. 6). As explained previously, AI models 604 are configurable to reduce task errors through real-time inspection and feedback on robotically or manually performed dexterous tasks that are predefined in workstation system 100 according to a sequence. In this example, AI workstation computing device 110 is implementing AI models 604. For instance, AI workstation computing device 110 may host all AI models 604 on premises. In other embodiments, AI workstation computing device 110 implements them as a front-end for a SaaS platform that is remotely hosted. In still other embodiments, AI workstation computing device 110 implements AI models 604 as a combination of local and SasS services.

In block 2402, process 2400 receives from a user, via the user interface display, a selected action builder from a set of step-specific actions to define a step in the sequence, different action builders of the set being configured to orchestrate a corresponding AI model for processing a corresponding sensor modality input.

In block 2404, process 2400 in response to selection of the selected action builder, presents on the user interface display an action-configuration user interface including a user-actuatable input and real-time video from the video inspection camera, the real-time video showing a region of interest of a workpiece, the user-actuatable input for capturing of the step in the sequence.

In block 2406, process 2400 repeats the receiving and the presenting for each step of the sequence performed seriatim to the workpiece at the user-accessible workstation.

In block 2408, process 2400 receiving captured data representing each step of the sequence for training corresponding AI models to configure the real-time inspection and feedback corresponding to the robotically or manually performed dexterous tasks in the sequence.

In block 2410, process 2400, in response to a live deployment of the real-time inspection and feedback, monitors associated sensor modality input and presents to the user real-time feedback indicating success or failure for each step of the sequence.

In some embodiments, process 2400 may also include halting the live deployment in response to a failure indication to provide for corrective action before resuming the live deployment.

In some embodiments, process 2400 may also entail the corresponding sensor modality including optical character recognition.

In some embodiments, process 2400 may also entail the corresponding sensor modality including audio data.

In some embodiments, process 2400 may also entail the corresponding sensor modality including live-video camera data.

In some embodiments, process 2400 may also entail the corresponding sensor modality including time-series measurement data.

In some embodiments, process 2400 may also include presenting to the user real-time feedback indicating a failure by displaying on the user interface the real-time video from the video inspection camera and annotating an area therein showing an error in an observed step.

In some embodiments, process 2400 may also include monitoring the associated sensor modality input by performing an OCR on component labels of the workpiece.

In some embodiments, process 2400 may also include tracking and reporting one or more of a duration of each step, error rates for each step, error rate of each sequence or assembly, completion of each sequence or assembly in a time period, and parts used in each sequence or assembly to feedback into an ERP or MRP system for inventory management.

In some embodiments, process 2400 may also include the video inspection camera being mounted on a robotic arm that provides triggers as steps in the sequence.

In some embodiments, process 2400 may also entail the time-series measurement data including multimeter data. In some embodiments, process 2400 may also entail the time-series measurement data including torque data. In some embodiments, process 2400 may also entail the time-series measurement data including fluid dispensing tool data.

In some embodiments, process 2400 may also entail establishing a trained AI model and distributing the trained AI model to another workstation system that is communicatively coupled via a network with the workstation system. This allows for consistency and rapid scaling.

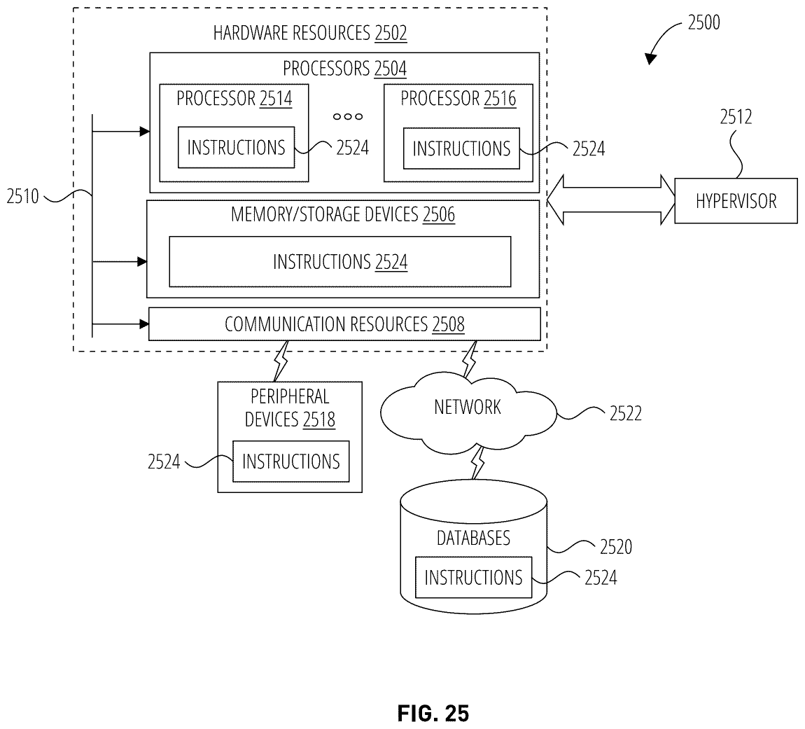

FIG. 25 is a block diagram illustrating components 2500, according to some example embodiments, able to read instructions from a machine-readable or computer-readable medium (e.g., a non-transitory machine-readable storage medium) and perform any one or more of the methods discussed herein, such any layer described in connection with FIG. 6, FIG. 7, or as process 2400 (FIG. 24).

Specifically, FIG. 25 shows a diagrammatic representation of hardware resources 2502 including one or more processors 2504 (or processor cores), one or more memory/storage devices 2506, and one or more communication resources 2508, each of which may be communicatively coupled via a bus 2510. For embodiments where node virtualization (e.g., NFV) is utilized, a hypervisor 2512 may be executed to provide an execution environment for one or more network slices/sub-slices to utilize hardware resources 2502.

Processors 2504 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), another processor, or any suitable combination thereof) may include, for example, a processor 2514 and a processor 2516.

Memory/storage devices 2506 may include main memory, disk storage, or any suitable combination thereof. Memory/storage devices 2506 may include, but are not limited to, any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

Communication resources 2508 may include interconnection or network interface components or other suitable devices to communicate with one or more peripheral devices 2518 or one or more databases 2520 via a network 2522. For example, communication resources 2508 may include wired communication components (e.g., for coupling via a Universal Serial Bus (USB)), cellular communication components, NFC components, Bluetooth® components (e.g., Bluetooth® Low Energy), Wi-Fi® components, cellular, satellite, and other communication components. In some embodiments, communication resources 2508 may be used to distribute trained AI models to other workstation systems so that all systems in a facility, or throughout multiple facilities, are implemented with the same version of models.

Instructions 2524 may comprise software, a program, an application, an applet, an app, or other executable code for causing at least any of processors 2504 to perform any one or more of the methods discussed herein. Instructions 2524 may reside, completely or partially, within at least one of processors 2504 (e.g., within the processor's cache memory), memory/storage devices 2506, or any suitable combination thereof. Furthermore, any portion of instructions 2524 may be transferred to hardware resources 2502 from any combination of peripheral devices 2518 or databases 2520. Accordingly, the memory of processors 2504, memory/storage devices 2506, peripheral devices 2518, and databases 2520 are examples of computer-readable and machine-readable media.

In one embodiment, a non-transitory computer-readable storage medium 2506 is included a workstation system that is configured for automating deployment of AI models. The AI models are configurable to reduce task errors through real-time inspection and feedback on robotically or manually performed dexterous tasks that are predefined in the workstation system according to a sequence. The workstation system includes a video inspection camera for monitoring a user-accessible workstation, a user interface display, and workstation computing device implementing the AI models. The computer-readable storage medium 2506 includes instructions 2524 that, when executed by the workstation system, cause it to: receive from a user, via the user interface display, a selected action builder from a set of step-specific actions to define a step in the sequence, different action builders of the set being configured to orchestrate a corresponding AI model for processing a corresponding sensor modality input; in response to selection of the selected action builder, present on the user interface display an action-configuration user interface including a user-actuatable input and real-time video from the video inspection camera, the real-time video showing a region of interest of a workpiece, the user-actuatable input for capturing of the step in the sequence; repeat the receiving and the presenting for each step of the sequence performed seriatim to the workpiece at the user-accessible workstation; receive captured data representing each step of the sequence for training corresponding AI models to configure the real-time inspection and feedback corresponding to the robotically or manually performed dexterous tasks in the sequence; and in response to a live deployment of the real-time inspection and feedback, monitor associated sensor modality input and presenting to the user real-time feedback indicating success or failure for each step of the sequence.

### CONCLUDING REMARKS

In light of this disclosure, skilled persons will appreciate that many changes may be made to the details of the above-described embodiments without departing from the underlying principles of the invention. The scope of the present invention should, therefore, be determined only by claims and equivalents.

What is claimed is:

1. A modular inspection assembly, comprising:
a camera;
a linear rail and carriage for the camera, the linear rail configured to allow movement of the camera along an axis enabling adjustable positioning of the camera relative to an inspection target;
a gimbal system providing rotational movement of the camera to orient the camera for capturing various inspection angles; and
an AI industrial computer implementing AI models, each trained to perform specific inspection tasks, and an image processing unit manage the positioning and operation of the camera, linear rail, and gimbal system, allowing automated and flexible inspection of workpiece targets in real-time.

2. The modular inspection assembly of claim 1, in which the rotational movement is around an axis that is parallel to that of the linear rail.

3. The modular inspection assembly of claim 1, in which the rotational movement is around an axis that is transverse to that of the linear rail.

4. The modular inspection assembly of claim 1, in which the linear rail is a two-axis linear rail.

5. The modular inspection assembly of claim 1, in which the rotation movement include multiple degrees of freedom.

6. The modular inspection assembly of claim 1, in which the AI industrial computer configures the camera to move through a sequence preconfigured and discrete inspection poses during an inspection task.

7. The modular inspection assembly of claim 1, in which the AI industrial computer configures the camera to continuously move through a tracking shot of dynamic inspection poses during an inspection task.

8. A method, performed by a workstation system, for automating deployment of AI models, the AI models being configurable to reduce task errors through real-time inspection and feedback on robotically or manually performed dexterous tasks that are predefined in the workstation system according to a sequence, the workstation system including a video inspection camera for monitoring a user-accessible workstation, a user interface display, and workstation computing device implementing the AI models, the method comprising:
receiving from a user, via the user interface display, a selected action builder from a set of step-specific actions to define a step in the sequence, different action builders of the set being configured to orchestrate a corresponding AI model for processing a corresponding sensor modality input;
in response to selection of the selected action builder, presenting on the user interface display an action-configuration user interface including a user-actuatable input and real-time video from the video inspection camera, the real-time video showing a region of interest of a workpiece, the user-actuatable input for capturing of the step in the sequence;
repeating the receiving and the presenting for each step of the sequence performed seriatim to the workpiece at the user-accessible workstation;
receiving captured data representing each step of the sequence for training corresponding AI models to configure the real-time inspection and feedback corresponding to the robotically or manually performed dexterous tasks in the sequence; and
in response to a live deployment of the real-time inspection and feedback, monitoring associated sensor modality input and presenting to the user real-time feedback indicating success or failure for each step of the sequence.

9. The method of claim 8, further comprising halting the live deployment in response to a failure indication to provide for corrective action before resuming the live deployment.

10. The method of claim 8, in which the corresponding sensor modality includes optical character recognition.

11. The method of claim 8, in which the corresponding sensor modality includes audio data.

12. The method of claim 8, in which the corresponding sensor modality includes live-video camera data.

13. The method of claim 8, in which the corresponding sensor modality includes time-series measurement data.

14. The method of claim 13, in which the time-series measurement data includes multimeter data.

15. The method of claim 13, in which the time-series measurement data includes torque data.

16. The method of claim 13, in which the time-series measurement data includes fluid dispensing tool data.

17. The method of claim 8, in which the presenting to the user real-time feedback indicating a failure comprises displaying on the user interface the real-time video from the video inspection camera and annotating an area therein showing an error in an observed step.

18. The method of claim 8, in which the monitoring associated sensor modality input comprises performing an OCR on component labels of the workpiece.

19. The method of claim 8, further comprising tracking and reporting one or more of a duration of each step, error rates for each step, error rate of each sequence or assembly, completion of each sequence or assembly in a time period, and parts used in each sequence or assembly to feedback into an ERP or MRP system for inventory management.

20. The method of claim 8, in which the video inspection camera is mounted on a robotic arm that provides triggers as steps in the sequence.

21. The method of claim 8, in which the receiving captured data representing each step of the sequence for training corresponding AI models to configure the real-time inspection and feedback corresponding to the robotically or manually performed dexterous tasks in the sequence, further comprises:
establishing a trained AI model; and
distributing the trained AI model to another workstation system that is communicatively coupled via a network with the workstation system.

22. A workstation system for automating deployment of AI models, the AI models being configurable to reduce task errors through real-time inspection and feedback on robotically or manually performed dexterous tasks that are predefined in the workstation system according to a sequence, the workstation system comprising:
a video inspection camera for monitoring a user-accessible workstation;
a user interface display; and
a workstation computing device implementing the AI models and configuring the workstation system to:
receive from a user, via the user interface display, a selected action builder from a set of step-specific actions to define a step in the sequence, different action builders of the set being configured to orchestrate a corresponding AI model for processing a corresponding sensor modality input;
in response to selection of the selected action builder, present on the user interface display an action-configuration user interface including a user-actuatable input and real-time video from the video inspection camera, the real-time video showing a region of interest of a workpiece, the user-actuatable input for capturing of the step in the sequence;
repeat the receiving and the presenting for each step of the sequence performed seriatim to the workpiece at the user-accessible workstation;
receive captured data representing each step of the sequence for training corresponding AI models to configure the real-time inspection and feedback corresponding to the robotically or manually performed dexterous tasks in the sequence; and
in response to a live deployment of the real-time inspection and feedback, monitor associated sensor modality input and presenting to the user real-time feedback indicating success or failure for each step of the sequence.
